(19) United States
(12) Patent Application Publication
(10) Pub. No.: US 2012/0076459 A1
(43) Pub. Date: Mar. 29, 2012

(54) Fiber Optic Cable Assembly And Methods

(75) Inventor: Nathan Sell, Dallastown, PA (US)

(73) Assignee: Bel Fuse (Macao Commercial Offshore) Limited

(21) Appl. No.: 12/892,152

(22) Filed: Sep. 28, 2010

(51) Int. Cl. G02B 6/36; B23P 19/00; G02B 6/26

(52) U.S. Cl. 385/76; 29/428

(57) ABSTRACT

A fiber optic cable assembly including at least one fiber optic cable including a plurality of optical fibers, a plurality of connectors pre-terminating at least some of the optical fibers, at least two interconnection modules having respective couplers, and wherein at least some of the connectors of the pre-terminated optical fibers of the at least one fiber optic cable are received and held in a coupler of each of the at least two interconnection modules. The cable is pulled through the ducts, conduit, etc. with the interconnection modules being separated from each other. The interconnection modules are small enough so that it is practical for them to be covered by a protective grip or boot and pulled through ducts, conduit or the like. The interconnection modules are preferably provided with attachment elements for attaching the interconnection modules to each other after the cable pull is completed to form an integrated modular array.

### FIELD OF THE INVENTION

This invention relates generally to fiber optic cabling and, more particularly, to a pre-terminated fiber optic cable assembly and methods for making and installing a fiber optic cable assembly.

### BACKGROUND OF THE INVENTION

The use of fiber optic cables for carrying transmission signals is widespread, such as in the telecommunication industry. There are several types of fiber optic cables. Typically, a fiber optic cable may include at least one optical fiber composed of a light carrying core and a cladding that traps the light in the core. A plastic buffer coating may surround the fiber for protection and the fiber covered by the buffer coating is situated in an outer jacket. Distribution cable, breakout cable and loose tube cable are examples of fiber optic cable used in premises installations that contain a plurality of optical fibers.

Generally, fiber optic cable is installed in premises by pulling an end of the cable through ducts, conduits, plenums and the like. Strength members such as central strength members and/or aramid strength members within the cable are used in fiber optic cables to keep any tensile installation load from being applied to the light carrying core, which is generally formed of glass, as this can cause reduced performance and possibly system failure.

After the fiber optic cable has been installed, i.e., pulled to a desired location, the optical fibers are generally connected to other optical fibers which may run to and from other optical electronic equipment, wiring closets, workstations and the like. The connection is often made through the use of a conventional patch panel or other type of distribution panel. In this regard, each optical fiber in the pulled cable or cables is terminated by a connector. There are several conventional types of connectors, such as connectors designated LC, SC, ST and MPO. Certain connectors, such as the LC type, terminate a single optical fiber. Other connectors, such as the MPO type, terminate multiple optical fibers. A patch panel includes a plurality of couplers, each of which is adapted to receive one or more connectors of the pulled cable and one or more corresponding connectors terminating optical fibers to which the pulled optical fibers are to be coupled. The couplers serve to align the connectors to align the optical fibers to accomplish optical connections. The connectors of the pulled cables can be connected and disconnected from the patch panel couplers to arrange the circuits as desired.

While the optical fibers of a fiber optic cable can be terminated on site, i.e., the connectors can be attached to the ends of the optical fibers after the pull has been completed, pre-termination of the optical fibers is becoming commonplace. Thus, fiber optic cable in which the optical fibers have been terminated with conventional connectors by the manufacturer prior to installation of the cable is now widely available.

In the case of such pre-terminated cables, proper precautions are necessary to protect the connectors during the pulling and installation operation. Generally, prior to the pull, a protective boot or grip is installed over the connectors and attached to the strength members of the cable. The protective boot is removed after the cable has been pulled whereupon the connectors are inserted into the patch panel couplers.

As the complexity of fiber optic connections increases, fiber management becomes increasingly more difficult. As the number of connections at a distribution panel increases, the possibility of errors in connecting the individual optical fibers to the couplers also increases. Exchanging or changing the locations at which individual connectors are mated is also a time-consuming and error prone process. In at least a partial response to these problems, connections are sometimes made using cassettes, generally having a width of between four to six inches. The cassette includes one or more couplers into which a plurality of connectors of the pulled cable are inserted at the receiving end of the cable pull. The cassette is then attached to a correspondingly sized opening in the distribution or patch panel.

Heretofore, it has not been practical to insert the connectors of a pre-terminated fiber optic cable assembly into couplers of a cassette or module prior to completion of the cable pull because of the size of the cassette. In particular, the cassette or module, generally having an industry standard width of between about four to six inches, is too large to be pulled through the ducts. For example, it would not be practical to install a protective boot or grip over the cassette to protect the connectors during the cable pull due to the size of the cassette.

### SUMMARY OF THE INVENTION

Accordingly, one object of an embodiment of the present invention is to provide a new and improved pre-terminated fiber optic cable assembly.

Another object of an embodiment of the present invention is to provide a new and improved fiber optic cable assembly having a plurality of pre-terminated optical fibers which are pre-connected, i.e. connected prior to the cable pull, to at least two interconnection modules.

Still another object of an embodiment of the present invention is to provide a new and improved fiber optic cable assembly having a plurality of pre-terminated optical fibers which are pre-connected to at least two interconnection modules which are attachable to each other after installation of the cable to form an integrated modular array.

A further object of an embodiment of the present invention is to provide a new and improved fiber optic cable assembly having a plurality of pre-terminated optical fibers which are pre-connected to at least two interconnection modules which are attachable to each other after installation of the cable to form an integrated modular array and further including an adapter panel structured to receive and hold the integrated modular array.

Another object of an embodiment of the present invention is to provide a new and improved method of making a fiber optic cable assembly.

Still another object of an embodiment of the present invention is to provide a new and improved method of installing a fiber optic cable assembly.

Briefly, in accordance with one aspect of the present invention, these and other objects are attained by providing in one embodiment of the invention, a fiber optic cable assembly comprising at least one fiber optic cable including a plurality of optical fibers, a plurality of connectors pre-terminating at least some of the optical fibers, at least two interconnection modules having respective couplers, and wherein at least some of the connectors of the pre-terminated optical fibers of the at least one fiber optic cable are received and held in a coupler of each of the at least two interconnection modules. The cable is pulled through the ducts, conduit, etc. with the interconnection modules being separated from each other. The interconnection modules are small enough so that it is practical for them to be covered by a protective grip or boot and pulled through ducts, conduit or the like.

The interconnection modules are preferably provided with attachment elements for attaching the interconnection modules to each other after the cable pull is completed to form an integrated modular array. The integrated modular array may have a width similar to a conventional cassette, e.g., in the range of between about four and six inches. An adapter panel is preferably provided which is structured to receive the integrated modular array for mounting in a patch panel.

According to another aspect of the present invention, these and other objects are attained by providing a method for making a fiber optic cable assembly including the steps of pre-terminating a plurality of optical fibers included in at least one fiber optic cable and inserting at least some of the connectors pre-terminating the plurality of optical fibers into the couplers of at least two interconnection modules prior to the cable being pulled through ducts, conduit or the like.

According to still another aspect of the present invention, these and other objects are attained by providing a method for installing a fiber optic cable assembly including the steps of providing at least one fiber optic cable assembly including a plurality of optical fibers, respective connectors terminating at least some of the optical fibers and at least two interconnection modules, each interconnection module including at least one coupler. Prior to installation, each of the connectors are inserted and held within a coupler of one of the at least two interconnection modules. An end of the fiber optic cable assembly, including the at least two interconnection modules is then pulled through a duct, conduit or plenum. A protective boot may be provided to cover and protect the at least two interconnection modules during the pulling operation.

### DETAILED DESCRIPTION OF THE DRAWINGS

A more complete appreciation of the present invention and many of the attendant advantages thereof will be obtained as the same becomes better understood with reference to the following detailed description when considered in connection with the accompanying drawings in which:

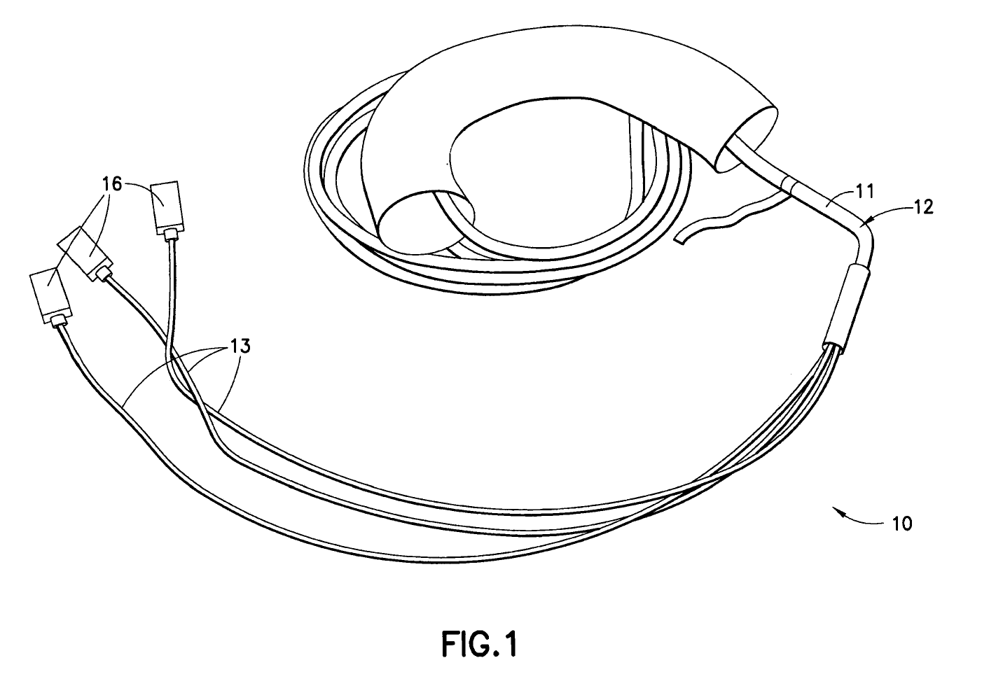

FIG. 1 is a perspective view of one embodiment of a fiber optic cable assembly in accordance with the present invention;

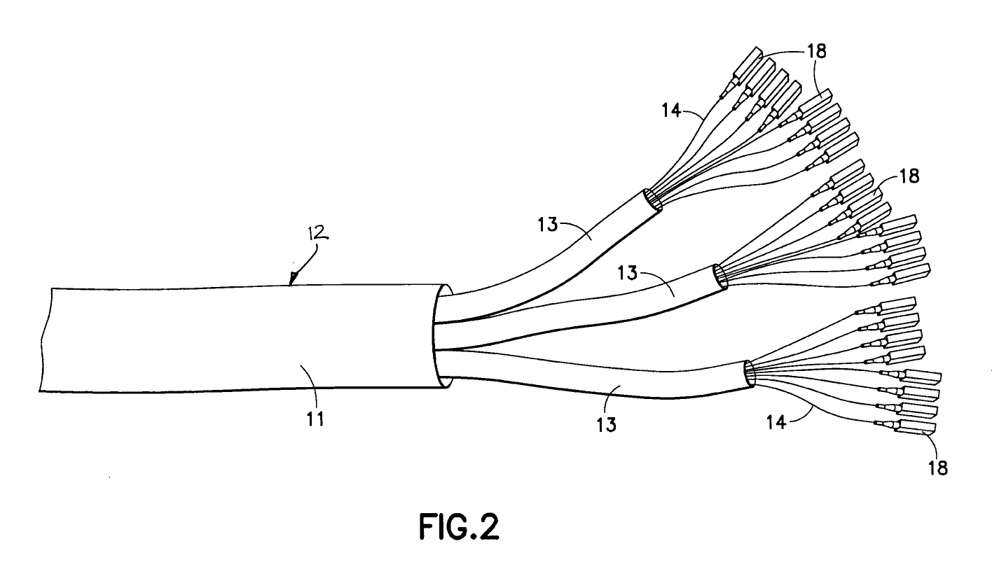

FIG. 2 is a perspective view of one embodiment of a fiber optic cable constituting a component of the fiber optic cable assembly of FIG. 1;

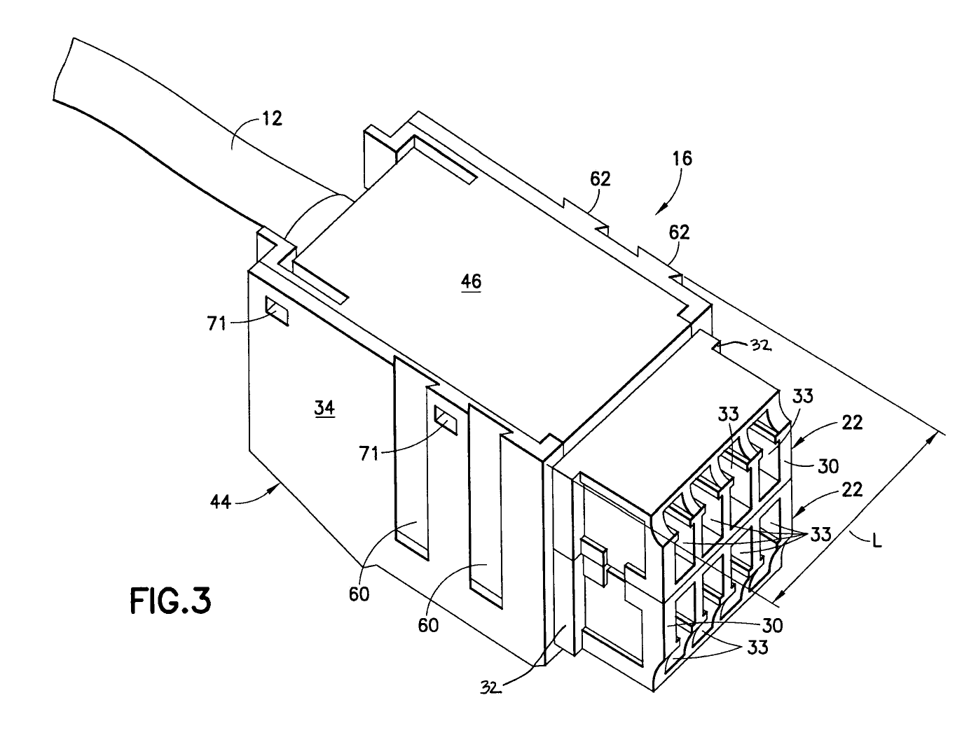

FIG. 3 is a perspective view of an interconnection module constituting a component of the fiber optic cable assembly of FIG. 1;

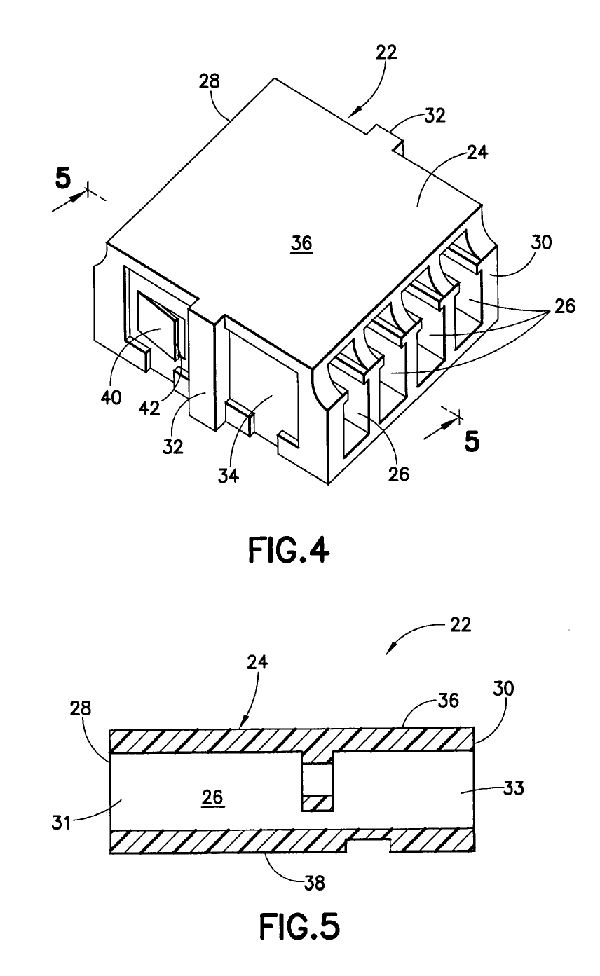

FIG. 4 is a perspective view of a coupler of the interconnection module shown in FIG. 3;

FIG. 5 is a section view taken along line 5-5 of FIG. 4;

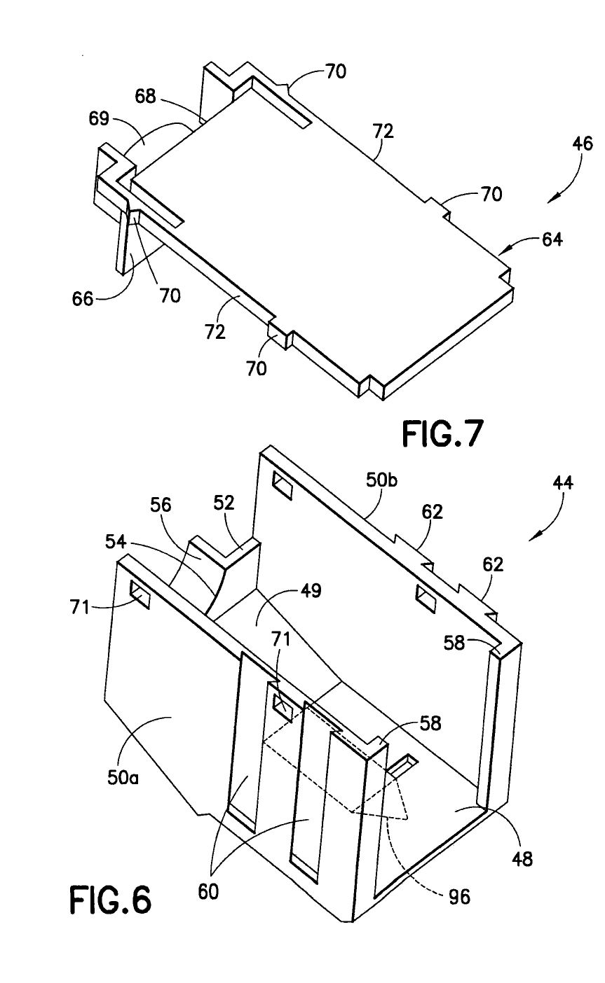

FIG. 6 is a perspective view of a lower part of a housing of the interconnection module shown in FIG. 3;

FIG. 7 is a perspective view of a cover part of a housing of the interconnection module shown in FIG. 3;

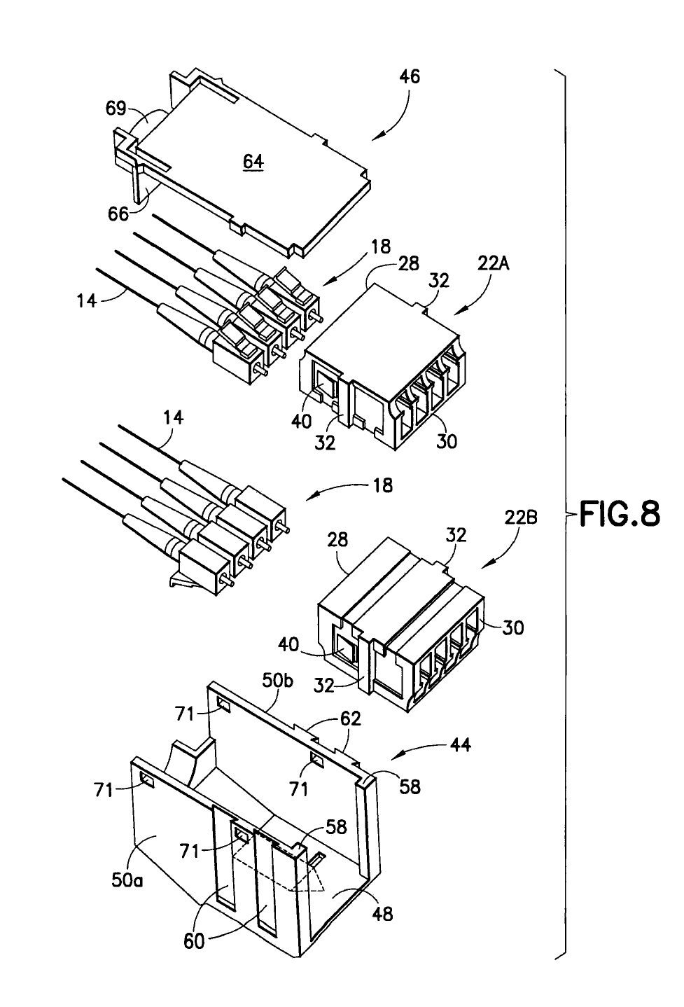

FIG. 8 is an exploded perspective view showing the components of the interconnection module shown in FIG. 3;

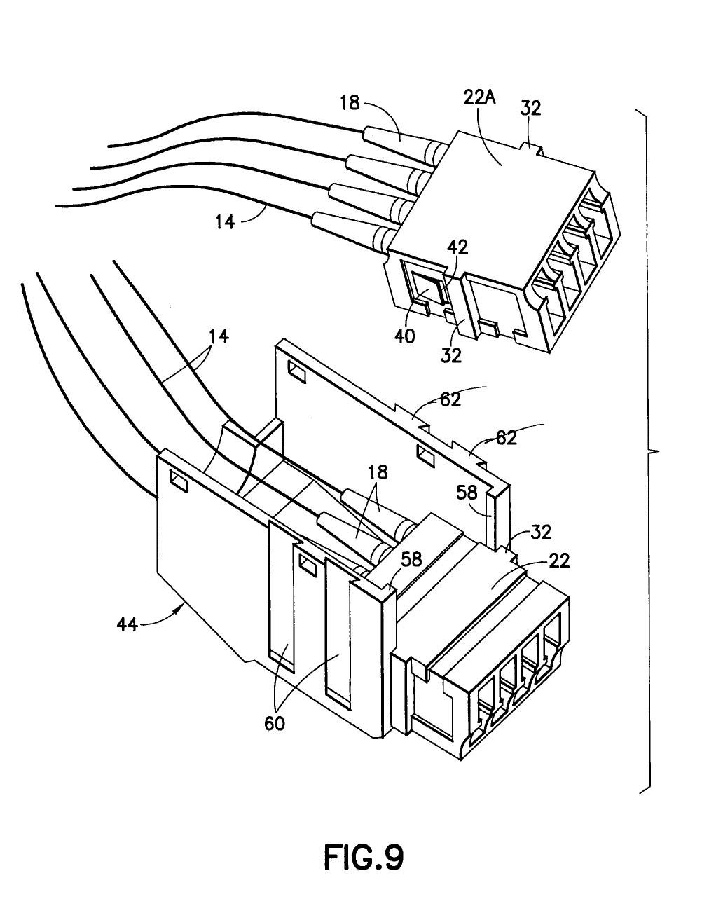

FIG. 9 is a perspective view showing a first stage of assembly of the interconnection module shown in FIG. 3;

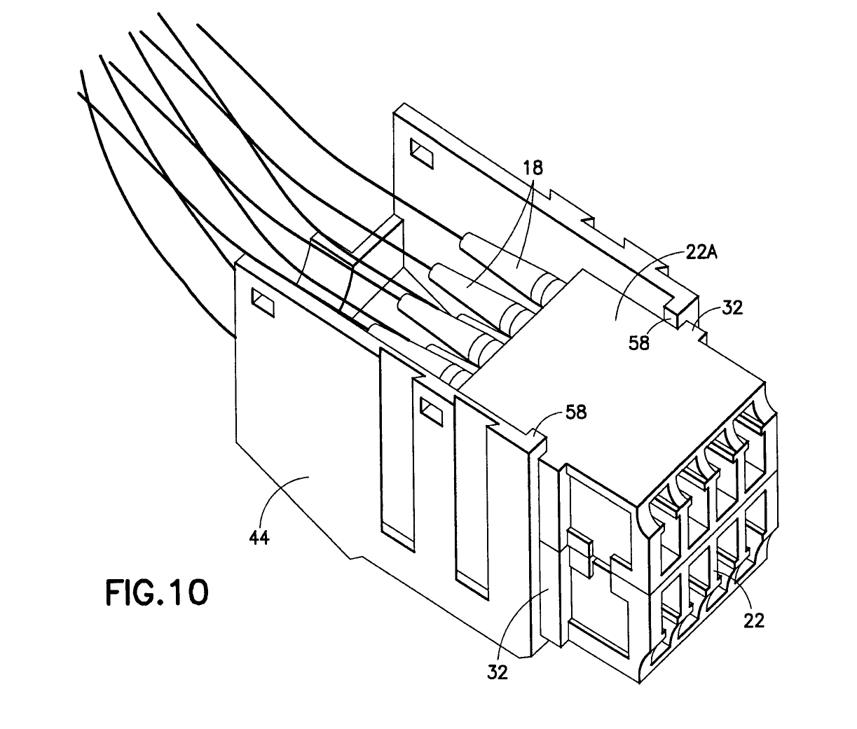

FIG. 10 is a perspective view showing a second stage of assembly of the interconnection module show in FIG. 3;

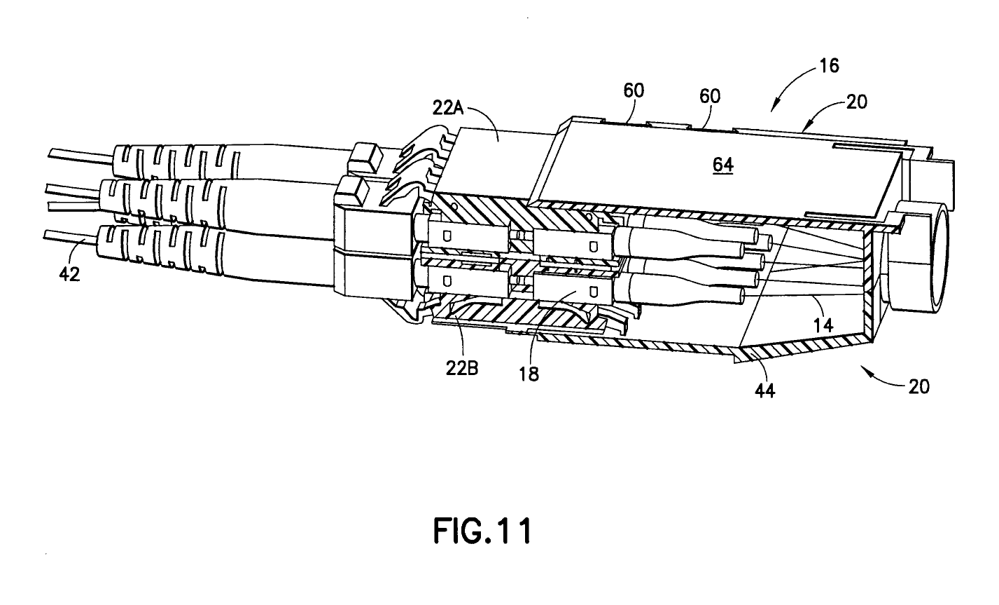

FIG. 11 is a perspective view, partially broken away, of the embodiment of a fiber optic cable assembly shown in FIG. 1 along with connectors terminating optical fibers of one or more other fiber optic cables received in an interconnection module of the fiber optic cable assembly;

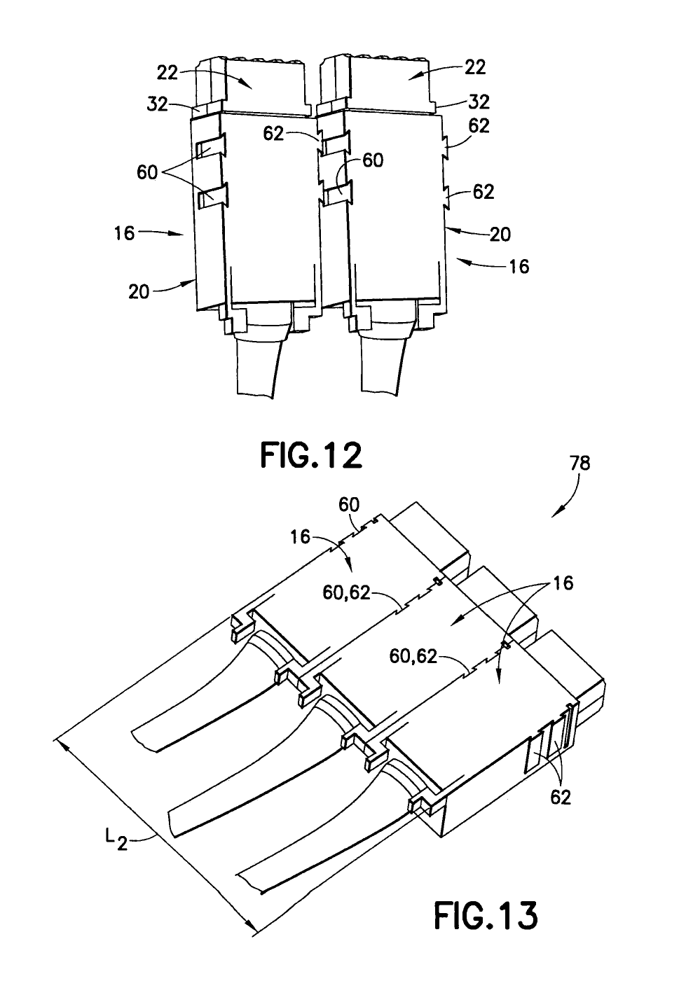

FIG. 12 is a perspective view showing the attachment to each other of two interconnection modules of the embodiment of a fiber optic cable assembly shown in FIG. 1;

FIG. 13 is a perspective view of an integrated modular array of an embodiment of a fiber optic cable assembly in accordance with the invention formed by the attachment to each other of three interconnection modules of the type shown in FIG. 1;

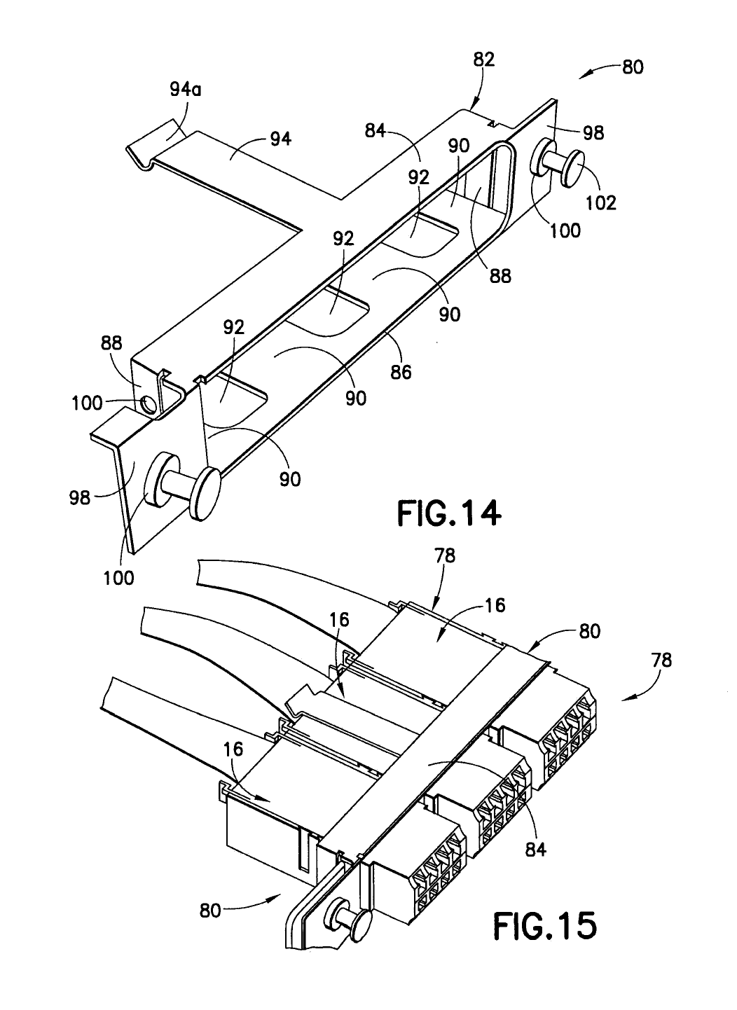

FIG. 14 is a perspective view of an adapter panel for receiving an integrated modular array formed of interconnection modules of a fiber optic cable assembly of the type shown in FIG. 1;

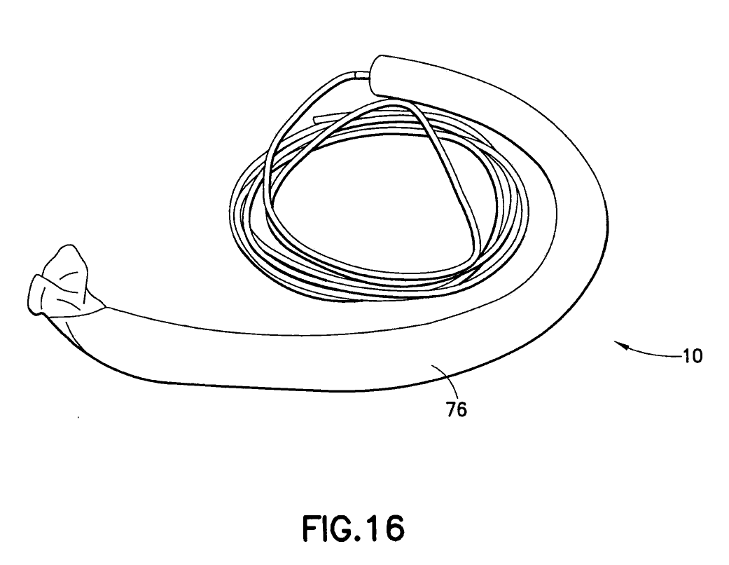

FIG. 15 is a perspective view of an adapter panel in which an integrated modular array of an embodiment of a fiber optic cable assembly in accordance with the invention is situated; and

FIG. 16 is a perspective view of the embodiment of a fiber optic cable assembly shown in FIG. 1 with a protective boot covering the modular interconnection assemblies prior to pulling the cable;

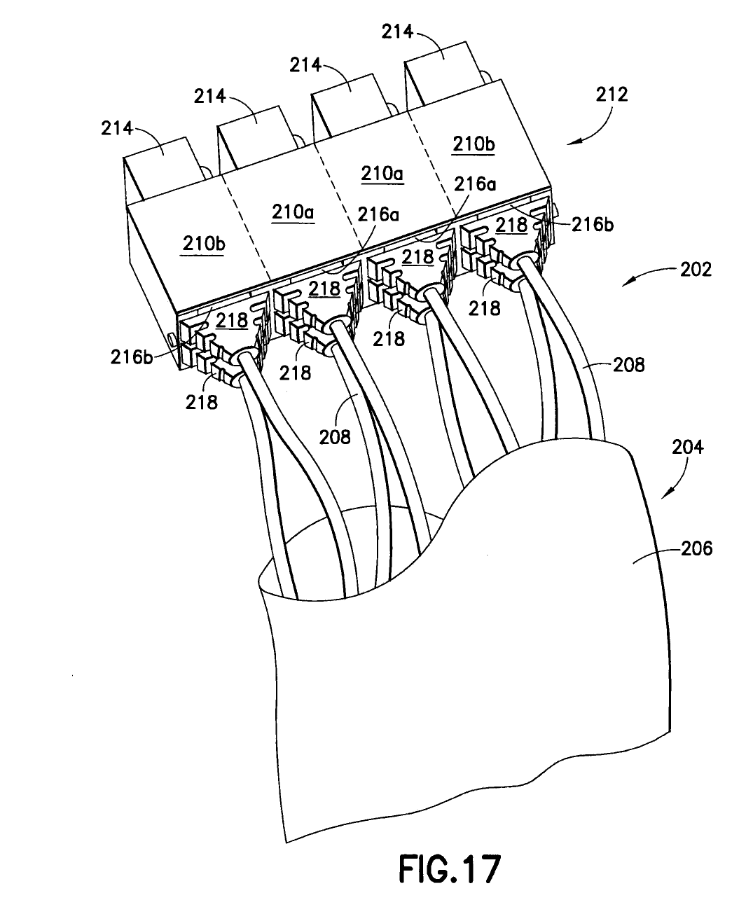

FIG. 17 is a perspective view showing a second embodiment of a fiber optic cable assembly in accordance with the present invention after a cable pull in which four interconnection modules are attached to each other to form an integrated modular array;

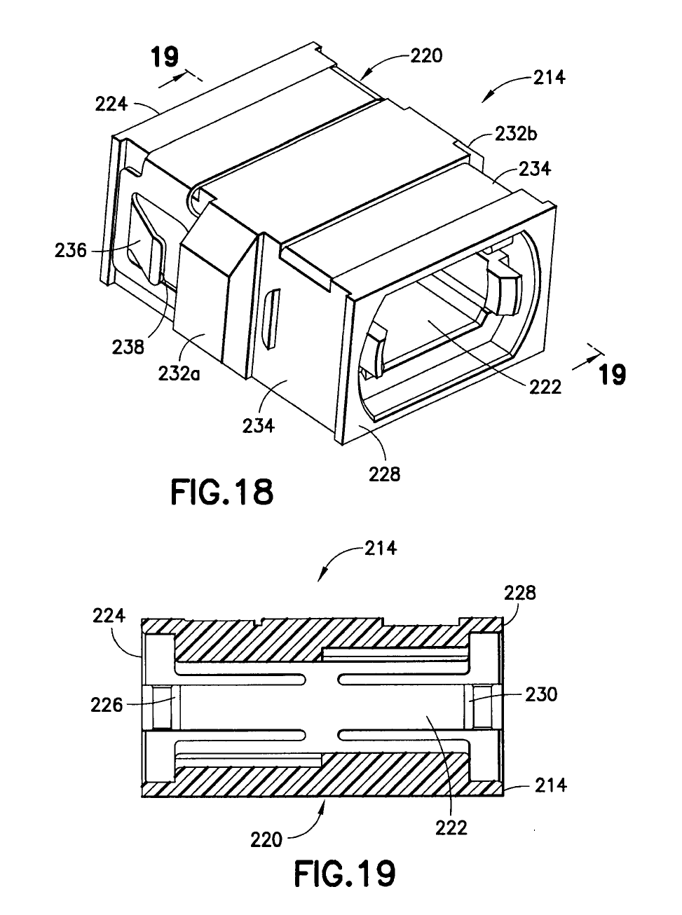

FIG. 18 is a perspective view of a coupler of an interconnection module of the embodiment shown in FIG. 16;

FIG. 19 is a longitudinal section view taken along line 19-19 of FIG. 18;

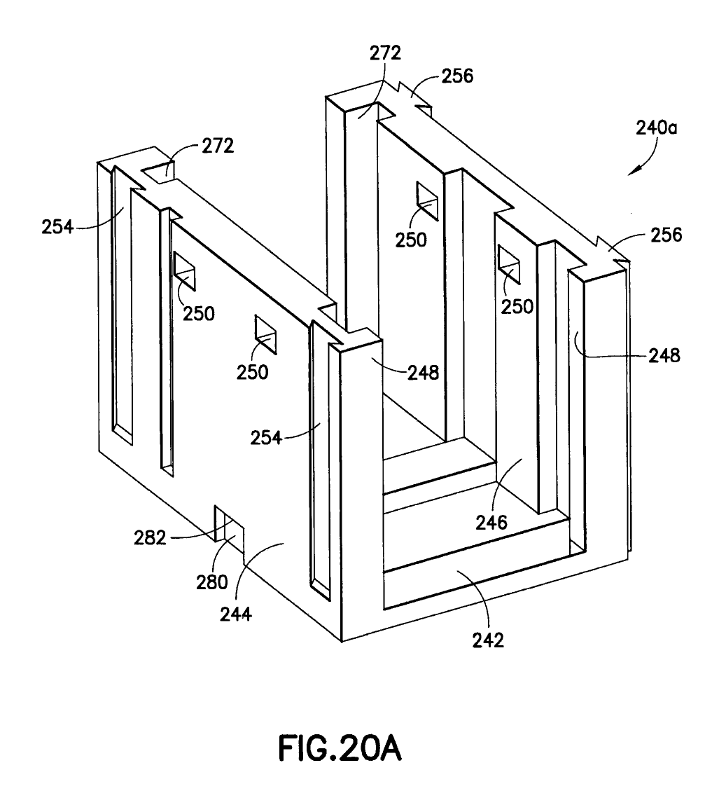

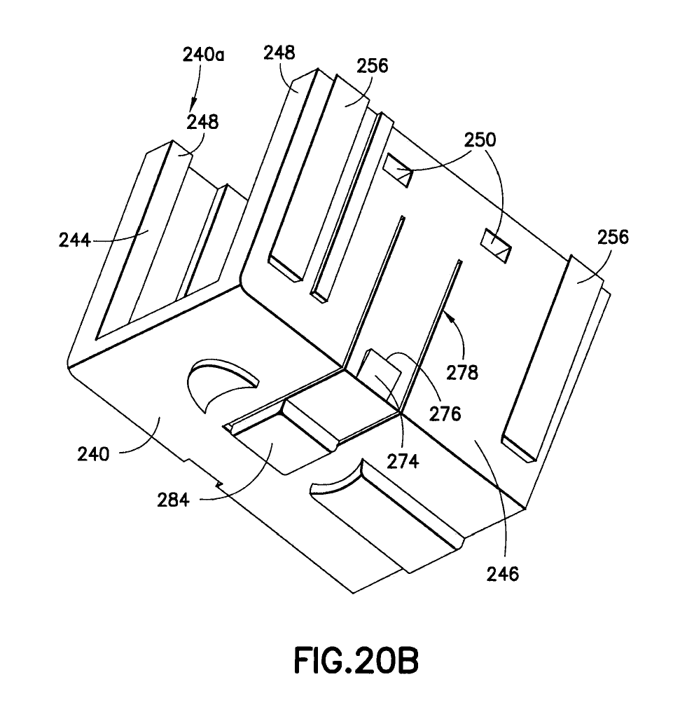

FIGS. 20A and 20B are top and bottom perspective views of the lower part of a housing of an intermediate interconnection module of the embodiment shown in FIG. 16;

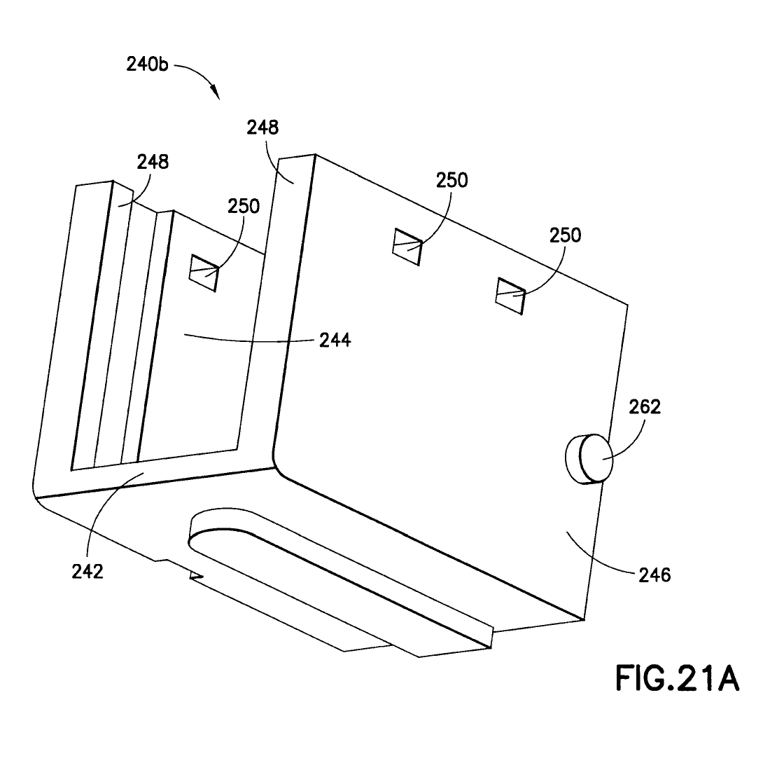

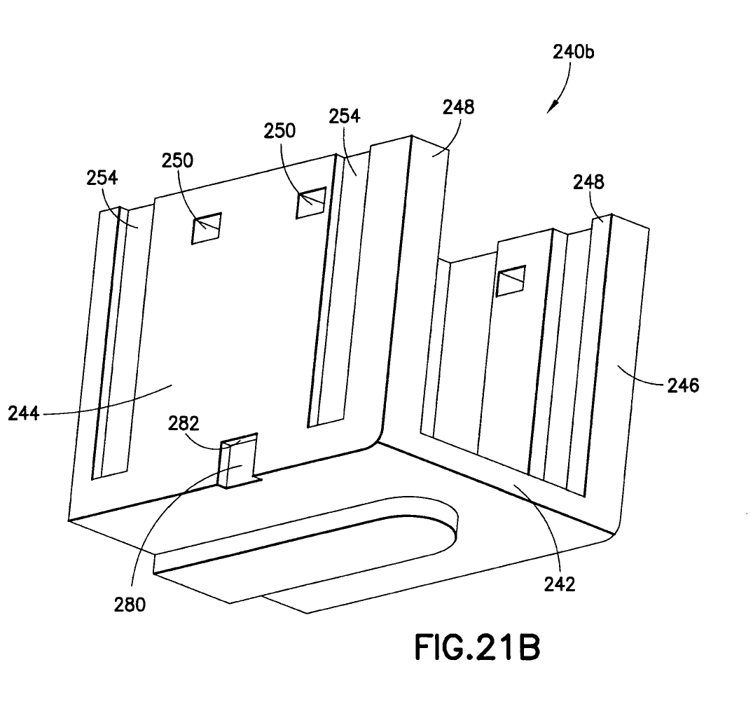

FIGS. 21A and 21B are right side and left side perspective views of the lower part of a housing of an end interconnection module of the embodiment shown in FIG. 16;

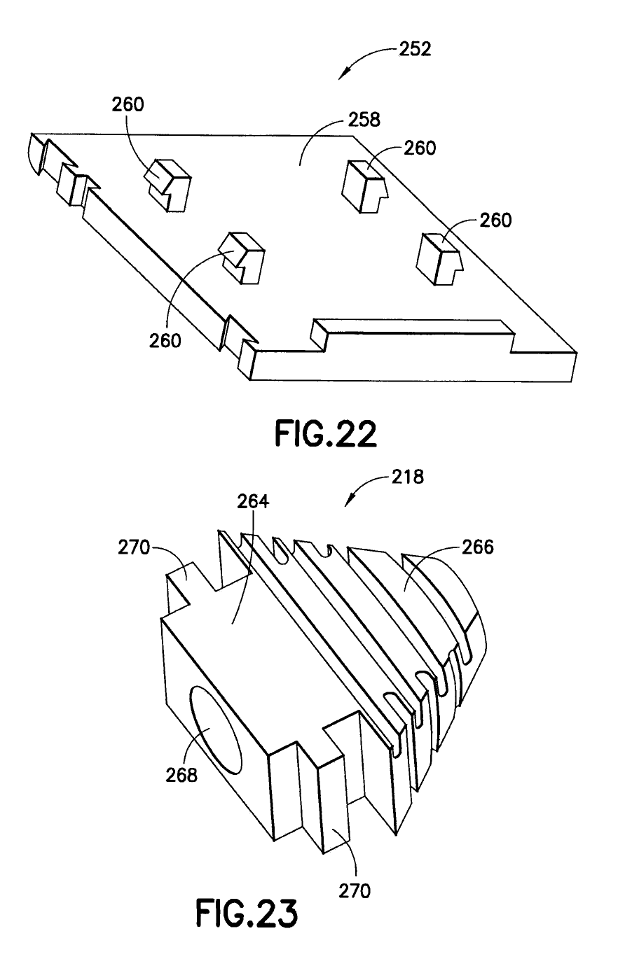

FIG. 22 is a bottom perspective view of a top part of a housing of an interconnection module of the embodiment shown in FIG. 16;

FIG. 23 is a perspective view of a coupler boot of an interconnection module of the embodiment shown in FIG. 16;

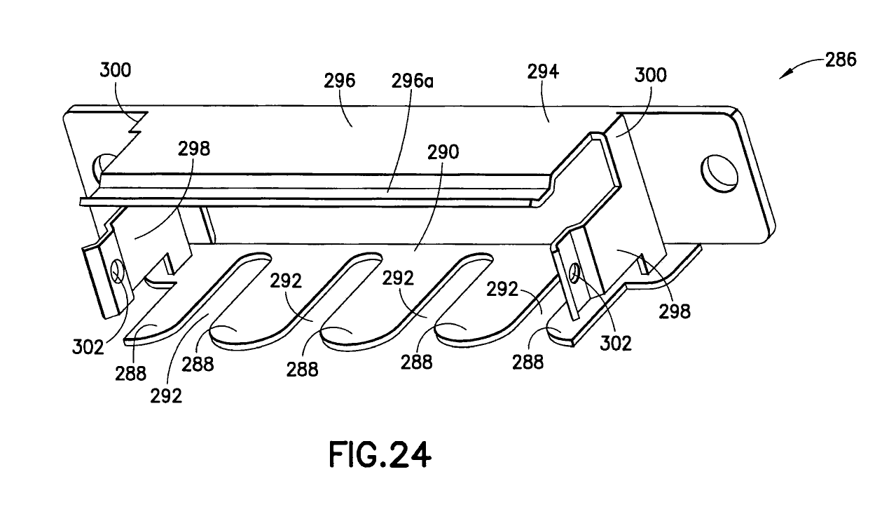

FIG. 24 is a perspective view of an adapter panel for use with the embodiment shown in FIG. 16; and

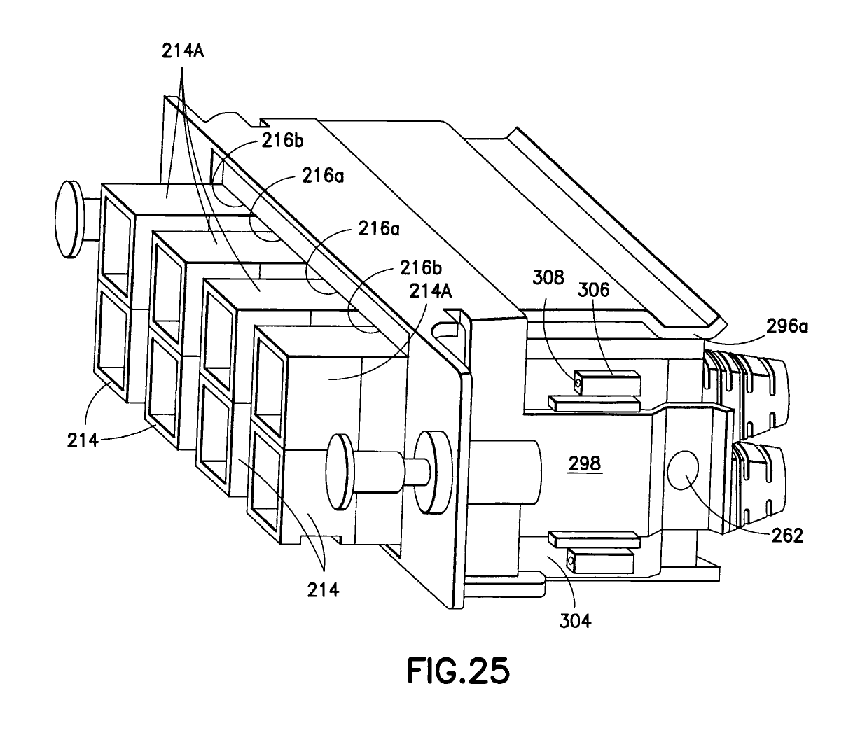

FIG. 25 is a perspective view showing an integrated modular array of the embodiment shown in FIG. 16 situated in an adapter panel.

### DETAILED DESCRIPTION OF THE PREFERRED EMBODIMENTS

Referring now to the drawings wherein like reference characters designate identical or corresponding parts throughout the several views, a fiber optic cable assembly in accordance with an embodiment of the present invention, generally designated 10, is illustrated in FIG. 1. Referring to FIGS. 1 and 2, the fiber optic cable assembly 10 includes a fiber optic cable 12 having an outer sheath 11 (FIG. 2) in which three inner sheaths 13 are enclosed, each inner sheath 13 surrounding eight optical fibers 14 so that the cable 12 includes a total of twenty-four optical fibers 14. Each of the optical fibers is pre-terminated by a respective optical fiber connector 18. The connectors 18 may be any one of the several industry standard types, such as LC, SC, ST, MPO or the like. The connectors shown in the illustrated embodiment comprise LC type connectors, each of which terminates a single optical fiber 14. The fiber optic cable assembly 10 further includes three interconnection modules 16, each of which is connected to eight respective optical fibers 14 of fiber optic cable 10.

Generally, referring to FIGS. 3-10, an interconnection module 16 of cable assembly 10 includes at least one coupler 22 which is structured to receive and precisely align one or more connectors terminating the optical fiber or fibers of the cable assembly with respective connectors terminating other optical fibers to thereby optically couple the cable optical fibers to the other optical fibers. In the illustrated embodiment, interconnection module 16 includes a pair of couplers 22. Each coupler 22 comprises a substantially rectangular block-shaped body 24, formed of plastic such as glass filled Valox® resin, through which four coupling passages 26 extend longitudinally and in parallel with each other, each passage 26 opening onto the rear or cable side 28 of the coupler body 24 at an opening 31 and onto the forward side 30 of the coupler body 24 at an opening 33. Each coupling opening 31, 33 is structured in a manner known in the art to receive and lockingly hold an LC fiber optic connector 18 therein so that the ends of the optical fibers which are terminated by a pair of connectors received in opposed openings 31, 33 of a coupling passage 26 are precisely aligned to thereby optically couple the fibers to each other. A pair of flanges 32 are formed on the lateral sides 34 of the coupler body 24 that extend between and perpendicular to the planes of the top and bottom sides 36 and 38 of the coupler body 24. A spring member 40 extends forwardly and outwardly from each of the lateral sides 34 of the coupler body 24 terminating at a forward edge 42 which is parallel to and spaced a short distance from a respective flange 32 to form a narrow gap therebetween. In the assembly of the fiber optic cable assembly, four connectors 18 terminating four optical fibers 14 of the fiber optic cable 12 are received and lockingly held in respective openings 31 of the coupling passages 26 at the rear or cable side 28 of the coupler body 24. In the illustrated embodiment, each of the interconnection modules 16 include a pair of couplers 22 so that a total of eight optical fibers 14 are connected to each interconnection module 16.

The interconnection module of a cable assembly in accordance with the invention may also include a housing structured to receive and hold the at least one coupler to which optical fibers of the fiber optic cable are connected. The at least one coupler is preferably held in the housing so that the openings 33 of the coupling passages opening onto the forward side of coupler body 24 are situated forwardly of the forward edges of the housing for easy access by connectors of other optical fibers after the cable has been pulled. Further, the housing is structured so that with the at least one coupler received and held therein, the connectors of the fiber optic cable assembly are situated within the housing and protected from external disturbances. Referring to FIGS. 3-10, the illustrated embodiment of the interconnection module 16 includes a box-shaped housing 20 in which a pair of couplers 22 are situated and held. The housing 20 is formed of plastic, such as glass filled Valox® resin, and includes a bottom part 44 and a top or cover part 46. The bottom housing part 44 has a bottom wall 48 with a trailing portion 49 angled upwardly to the rear and a pair of opposed upstanding side walls 50a, 50b extending from the side edges of the bottom wall 48 perpendicular to the bottom wall. The bottom part 44 of housing 20 also includes an upstanding rear wall 52 extending perpendicularly from the rear edge of the bottom wall 48. The rear wall extends to approximately one-half the height of the side walls 50a, 50b and has a semi-circular cutout 54 formed therein from which a semi-cylindrical collar portion 56 extends. A lip 58 extends inwardly from the forward edge of each of the side walls 50a, 50b of bottom part 44 of housing 20. A pair of grooves 60 having dovetail-shaped cross sections are formed in the outer surface of one of the sidewalls 50a and extend vertically from a lower region of the sidewall 50a and open at their tops onto the upper edge of the sidewall 50a. A pair of rails 62 having dovetail-shaped cross sections protrude outwardly from the outer surface of the other one of the housing sidewalls 50b and extend vertically from the lower edge to the upper edge of the sidewall 50b.

The top or cover part 46 of housing 20 comprises a substantially rectangular top wall 64 and a rear wall 66 which extends downwardly from the rear edge of top wall 64 perpendicular to the top wall 64 for a length of approximately one-half the height of the sidewalls 50a, 50b of the bottom part 44 of housing 20. The rear wall 66 of top housing part 46 has a semi-circular cutout 68 formed therein from which a semi-circular collar portion 69 extends. The top part 46 of housing 20 has a detent 70 formed on spring portions formed at the rear of each of the side edges of the top wall 64 of housing part 46. The detents are received in respective openings 71 formed through the respective sidewalls 50a, 50b when the housing top or cover part 46 is assembled to the housing bottom part 44. The side edges 72 of the top wall 64 of top housing part 46 are received in grooves 74 formed in the inner surfaces of the sidewalls 50a, 50b adjacent their upper edges when the top or cover part 46 is assembled to the bottom part 44 of the housing 20. It is seen that when the top or cover part 46 is assembled to the bottom part 44 of the housing, the forward end of the housing is open and an aperture is defined by the forward edges of the side and bottom walls of the bottom housing part 44 and the forward edge of the top wall 64 of housing cover part 46. The semi-circular cutouts in the free edges of the rear walls 52 and 66 of the bottom and top housing parts define a circular opening in the rear side of housing 20 which is bordered by a rearwardly extending cylindrical collar formed for the mating semi-cylindrical collar portions 56, 69.

Referring to FIGS. 8-10, in the assembly and connection of the interconnection module 16, four connectors 18 terminating a respective four of the optical fibers 14 of the fiber optic cable 12 are inserted into and lockingly held within the openings 31 of the coupling passages 26 of a coupler 22 that open at the rear or cable side 28 of coupler body 24 of coupler 20. The coupler 20 to which the optical fibers 14 are connected is situated within the bottom part 44 of housing 20. In this connection, the coupler 20 is initially located over the bottom housing part 44 prior to assembly of the top part 46 to the bottom part, so that the pair of lips 58 extending inwardly from the forward edges of the sidewalls 50a, 50b are aligned with respective gaps defined between the pair of flanges 32 and the opposed forward edges 42 of the spring members 40 on the lateral sides 34 of the coupler body 24. The coupler 22 and four optical fibers connected to the coupler are thus received within the bottom part 44 of housing 20 and situated on the bottom wall thereof (see FIG. 9). The location of the lips 58 in the gaps between the flanges 32 and the forward edges 42 of the spring members 40 fix the longitudinal position of the coupler 22 with the housing 20 so that the openings 33 of the coupling passages 26 that open onto the forward side 30 of coupler body 24 are situated forwardly of the forward edges of the housing to permit easy access by connectors of other optical fibers to the openings 33 after the cable has been pulled. As seen in FIG. 9, the connectors 18 inserted into the openings 31 of coupling passages 26 at the rear or cable side 28 of coupler body 24 along with a length of the optical fibers 14 terminated by them are situated within the bottom housing part 44.

Still referring to FIGS. 8-10 in connection with the assembly of interconnection module 16, another four connectors 18 terminating another four optical fibers 14 are similarly inserted into and lockingly held within the openings 31 of the coupling passages 26 of a second coupler 22A which is then situated in a fashion similar to the first coupler 22 within the bottom part 44 of housing 20 over the first coupler 22. Again, the inwardly extending lips 58 of the bottom housing part are situated in the gaps between the flanges 32 and the forward edges 42 of the spring members 40 to fix the coupler 22A with respect to the bottom housing part 44. As seen in FIG. 10, the forward portion of second coupler 22A projects forwardly of the forward edges of the bottom housing part 44 and the connectors 18 connected to the second coupler 22A and the portions of the optical fibers 14 proximate to the connectors 18 are situated within the lower housing part 44. The top or cover part 46 of housing 20 is then situated over the bottom part 44, the detents 70 of the top part 46 are situated in the openings 71 of the bottom part and the side edges 72 of top wall 64 of top housing part 46 are snapped into the grooves 74 formed in the inner surfaces of the sidewalls 50a, 50b. When the top housing part 46 is connected to the bottom housing part 44, the top side 36 of the body 24 of the second coupler 22A is contiguous with the bottom surface of the top wall 64 of the top housing part 46. The forward portions of the couplers 22, 22A project through the aperture defined at the forward end of housing 20, the eight connectors are enclosed within the housing 22, and the optical fibers 14 pass into and out from the interior of housing 20 through the circular opening in the rear side of housing 20 bordered by the cylindrical collar extending rearwardly from the housing.

In this manner, an interconnection module 16 is pre-connected to eight optical fibers 14 prior to installation of the fiber optic cable 12. It is understood that other embodiments of interconnection modules are possible. For example, an interconnection module may be structured and arranged for connection to more or less than eight optical fibers. An interconnection module may include a single coupler or more than two couplers.

Couplers 22 and 22A of interconnection module 16 are substantially identical in construction to each other but are situated in the housing 20 in mirror relationship with respect to the plane situated between them so that the latches of the LC connectors are desirably positioned to be pressed inwardly to disconnect a connector from either coupler. The forward sides 30 of the couplers 22 and 22A are flush or coplanar with each other and the openings 33 of the coupling passages are aligned in two vertically aligned rows of four openings. The length (L1 in FIG. 3) of interconnection module 16 is about 1¼ inches and the width (w) is about 2¾ inches. Other dimensions and configurations are possible.

The fiber optic cable 12 includes twenty-four optical fibers 14. It is generally not practical to provide a single interconnection module for pre-connection to all twenty-four fibers since in order to accommodate the larger number of connectors, the size of any such interconnection module would necessarily be increased such that it may become impractical or difficult to pull the end of the cable assembly through the conduits, ducts or the like without damage to the connectors or the module. For example, it would not be practical to install a protective boot or grip over a larger interconnection module prior to the pull. Preferably, the length of an interconnection module should not exceed about 1.5 inches.

In the illustrated embodiment, the fiber optic cable assembly 10 includes three modular interconnection assemblies 16, each of which is connected to a respective group of eight of the twenty-four fiber optical fibers 14 of cable 12. The three modular interconnection assemblies 16 have substantially the same construction as described above. Providing multiple interconnection modules, each connected to some of the optical fibers, as opposed for example, to a single, larger interconnection module connected to all of the optical fibers, enables the size of each module to be kept sufficiently small to facilitate the cable pull.

The fiber optic cable assembly 10 comprising the fiber optic cable 12 and the three interconnection modules 16, 16A and 16B connected to the cable fibers 14, is pulled through the conduit, ducts or the like. As seen in FIG. 16, a protective boot or grip 76 is installed over the interconnection modules 16, 16A and 16B extending over the ends of the inner sheaths 13 of cable 12, and attached to the strength members of the cable 12. The protective boot 76 is removed after the cable has been pulled.

In accordance with a preferred feature of the invention, after the pull has been completed, the multiple interconnection modules are connectable to each other to form an integrated modular array having a configuration suitable for mounting in standard patch panels or other types of distribution panels. For example, conventional unitary cassettes connected to multiple optical fibers typically have a length in the range of between four to six inches which is suitable for mounting in patch or other types of distribution panels. Referring to FIGS. 12 and 13, in the illustrated embodiment, the three interconnection modules 16, 16A and 16c are connectable to each other by the dovetail-shaped grooves 60 and rails 62 that extend vertically on the outer surfaces of respective sidewalls 50a, 50b of the housings 20 of the interconnection modules 16, 16A and 16B. For example, the interconnector modules 16 and 16A are situated with their respective sidewalls 50b and 50a adjacent to and vertically displaced from each other (FIG. 12) and the rails 62 on sidewall 50b of module 16 are slid into the grooves 60 on the sidewall 50a of the module 16A to each other. The interconnection module 16B is similarly connected to module 16A. The length of the resulting integrated modular array 78 (L2 in FIG. 13) in the illustrated embodiment is about four inches. It is understood that the length of an integrated modular array is not so limited.

Referring to FIGS. 14 and 15, an adapter panel 80 may be provided to facilitate mounting of the integrated modular array 78 in a patch panel or other type of distribution panel. Adapter panel 80 comprises a metallic frame 82 having a top wall 84, a bottom wall 86 and a pair of sidewalls 88 defining a rectangular space for receiving the integrated modular array 78. Four tabs 90 extend rearwardly, i.e. in the direction of the cable assembly 10, from the bottom wall 86 of the frame 82 and are equally spaced from each other to define three slots 92 between them. An arm 94 extends rearwardly from the top wall 84 of the frame 82 and terminates at its free end with a slanted spring surface 94a. A shallow, longitudinally extending shoulder 96 (FIG. 6) is formed on the central region of the outer surface of the bottom wall 48 of the housing 20 of each of the interconnection modules 16, 16A and 16B. In assembling the integrated modular array 78 into the rectangular space of adapter panel 80, these shoulders 96 become situated in the slots 92 between tabs 90 to accurately position the integrated modular array 78 within the adapter panel 80. The bottom surfaces of the modules 16, 16A and 16B are supported on the tabs 90. The spring surface 94a of arm 94 bears against the outer surface of the top wall 64 of the centrally situated module 16A of the integrated modular array 78 to hold the integrated modular array 78 in place along with the tabs 90. A pair of mounting flanges 98 extend laterally outwardly from the sidewall 88 of frame 82 of adapter panel 80. The flanges 98 have mounting holes or slots 100 formed in them for receiving threaded fasteners 102 for mounting the adapter panel carrying the integrated modular array of the cable assembly to a patch panel or other distribution panel.

The embodiment of the invention shown in FIGS. 1-16 incorporates LC type fiber optic connectors, each of which pre-terminates a single optical fiber. An embodiment of fiber optic cable assembly 202 (FIG. 17) in accordance with the invention is shown in FIGS. 17-25 which incorporates MPO type connectors. MPO type connectors can pre-terminate up to 72 optical fibers.

Referring to FIG. 17, cable assembly 202 is shown after completion of the cable pull. The cable assembly 202 includes a fiber optic cable 204 comprising an outer sheath 206 surrounding eight inner sheaths 208, each of which carries up to seventy-two optical fibers. The fiber optic cable 204 is connected to four interconnection modules 210 which, subsequent to completion of the cable pull, have been attached to each other to form an integrated modular array 212. Each integrated modular array 212 includes a pair of couplers 214, each coupler being structured and arranged for receiving a single MPO type connector of the cable assembly 202 and precisely aligning the multiplicity of optical fibers terminated by that connector with the optical fibers a similar connector terminating other optical fibers. The couplers 214 of each interconnection module 210 are partially enclosed in a housing 216. As discussed below, the housings 216 of the four interconnection modules 210 include elements for attaching the modules to each other to form the integrated modular array 212. A coupler boot 218 is associated with each coupler 214 of each interconnection module 210, so that in the illustrated embodiment, each interconnection module 210 includes a pair of coupler boots 218.

A coupler 214 constituting a component of an interconnection module 210 (see FIG. 23) for MPO type connectors is shown in FIGS. 18 and 19. The coupler 214 includes a substantially rectangular block-shaped body 220 formed of plastic, such as glass filled Valox® resin, through which a single coupling passage 222 longitudinally extends opening onto the rear or cable side 224 of coupler body 220 at an opening 226 and onto the forward side 228 of coupler body 220 at an opening 230. Each coupling opening 226, 230 is structured in a manner known in the art to receive and locking hold an MPO type connector so that the ends of the optical fibers terminated by the connectors which are received in opposed openings 226, 230 of coupling passage 222 are precisely aligned to thereby optically couple the fibers to each other. A pair of flanges 232 are formed on the lateral sides 234 of the coupler body 220 and a spring member 236 extends forwardly and outwardly from each of the lateral sides 234 of the coupler body 220 terminating at a forward edge 238 which is parallel to and spaced a short distance from a respective flange 232 to form a narrow gap therebetween. In the illustrated embodiment, an MPO type connector terminating a multiplicity of optical fibers is received and lockingly held in the single opening 226 at the rear or cable side 224 of the coupler body 220. Each of the interconnection modules 210 include a pair of couplers 214 so that a total of up to 144 optical fibers can be connected to each interconnection module 210.

An interconnection module 210 according to the embodiment shown in FIGS. 17-25 includes a housing 216 structured and arranged to at least partially receive and hold a pair of couplers 214 and 214A which are substantially identical to each other. The construction of the housings 216 of the interconnection modules 210 differ from each other depending on whether the module 210 in which the housing is incorporated is an intermediate module, designated 210a in FIG. 17 or is an end module, designated 210b in FIG. 17. An intermediate module 210a is situated in the integrated modular array 212 between two other modules. An end module 210b is situated at one of the two ends of the integrated modular array 212 so that it is adjacent to another module on one of its sides while its other side constitutes the end surface of the array 212. The bottom part of a housing of an intermediate module 210a is designated 240a in FIG. 20 and the bottom part of a housing of an end module 210b is designated 240b in FIG. 24.

Referring to FIG. 20, the bottom part 240a of the housing 216a of an intermediate interconnection module 201a includes a bottom wall 242 and a pair of opposed upstanding sidewalls 244 and 246 extending from the side edges of the bottom wall 242 perpendicular to the bottom wall 242. A lip 248 extends inwardly from the forward edge of each of the sidewalls 244, 246 and latch holes 250 for retaining a top cover part 252 (FIG. 22) are formed through the sidewalls 244, 246. A pair of dovetail-shaped grooves 254 are formed in the outer surface of sidewall 246 and extend vertically from a lower region of the sidewall 244 onto the upper edge of the sidewall 244. A pair of dovetail-shaped rails 256 protrude outwardly from the outer surface of the other sidewall 246 and extend vertically from the lower edge to the upper edge of sidewall 246.

Referring to FIG. 22, the top cover part 252 of housing 216a comprises a substantially rectangular top wall 258. The top part 252 includes four latches 260 which are structured and arranged to snap into respective latch holes 250 formed in the sidewalls 244, 246 of bottom housing part 240 to affix the top or cover part 252 to the bottom housing part 240. It is seen that when the top or cover part 252 is assembled to the bottom part 240, the forward and rearward ends of housing 216 are open.

Referring to the bottom housing part 240b shown in FIGS. 21A and 21B of each housing 216b of an end interconnection module 210b, the construction is similar to that of the bottom housing part 240a of an intermediate interconnection module 210a shown in FIGS. 20A and 20B. However, the outer surface of the sidewall 244, 246 constituting the end surface of the integrated modular array 212 of each of the end interconnection modules 210b do not include any dovetail-shaped grooves or rails. A locking stud 262 is formed on the rear portion of each of the sidewalls 244, 246 constituting the end surfaces of the array 212 for purposes described below. Referring to FIG. 23, coupler boot 218 is formed of a rubber, such as flexible PVC material, and includes a body portion 264 and pyramid-shaped end portion 266. A cylindrical opening 268 has ends that open at the forward side of body portion 264 and the rearward end of the end portion 266. Each coupler boot 218 includes a pair of flanges 270 projecting from the side surfaces of its body portion 264. Each of the bottom housing parts 240 have a pair of channels 272 formed in the inner surfaces of its sidewalls 244, 246 adjacent the rearward or cable ends thereof. A pair of boots 218 are connected to each of the bottom housing parts 240, one over the other, by sliding the coupler boot flanges 270 into the channels 272. The coupler boots 218 serve to direct the inner cable sheaths into respective couplers of respective interconnection modules.

In the assembly and connection of an interconnection module 210, a connector terminating a multiplicity of optical fibers is passed through the coupler boot opening 268 from the rear thereof and is inserted into and lockingly held within the opening 226 at the rear or cable side of the coupling passage 222 formed in the body 220 of a coupler 214. A coupler 214 to which the optical fibers are connected is situated within the bottom part of housing 216. In this connection, the coupler 214 is initially located over the bottom housing part 240 prior to the assembly of the top part 252 to the bottom part 240, so that the pair of lips 248 extending inwardly from the forward edges of the sidewalls 244, 246 are aligned with respective gaps defined between the pair of flanges 232 and the opposed forward edges 238 of the spring members 236. The coupler 214 and multiplicity of optical fibers connected to the coupler are then received within the bottom part 240 of housing 216 and situated on the bottom wall 242 thereof. The opening 230 at the forward side 228 of the coupler body 220 is situated forwardly of the forward edges of the housing to permit easy access by a connector of other optical fibers to the opening 230 after the cable has been pulled. The connector inserted into the cable-side opening 226 of coupling passage 222 is situated within the housing 216 which affords a degree of protection to the connector and the ends of the optical fibers during the pulling operation and thereafter.

In a similar fashion, another connector connected to another multiplicity of optical fibers is passed through the opening 268 of the other boot 218A which is situated above the boot 218 described above and is inserted into and lockingly held within the cable-side opening 226 of another coupler 214A which is then situated within the bottom part 240 of housing 216 over the first coupler 214. The lips 248 are situated between the flanges 232 and the forward edges 238 of spring members 236. The top or cover housing part 252 is then situated over the bottom housing part 240 and affixed thereto by the latches 260 which are received in latch holes 250. The forward portions of the couplers 214, 214A project through the aperture defined at the forward end of housing 216.

The fiber optic cable assembly 202 in this embodiment includes four interconnection modules 210, each of which is connected to a pair of MPO type connectors. As in the case of the embodiment shown in FIGS. 1-16, providing multiple interconnection modules 210, each connected to some of the optical fibers of the fiber optic cable 204 as opposed, for example, to a single larger interconnection module connected to all of the optical fibers, enables the size of each module to be kept sufficiently small to facilitate the cable pull.

The end of the fiber optic cable assembly 202 comprising the fiber optic cable 204 and the four unconnected interconnection modules 210 is pulled through the conduit, ducts or the like. As in the first embodiment, a protective boot may be installed over the interconnection modules.

As in the case of the embodiment of the invention shown in FIGS. 1-16, in accordance with a preferred feature of the invention, after the pull has been completed, the four interconnection modules 210 are connectable to each other to form the integrated modular array 212 having a configuration suitable for mounting in standard patch panels or the like. In particular, as described above, the side walls 244, 246 of the housings are provided with correspondingly situated dovetail-shaped grooves and rails 254, 256. After the pull has been completed, the interconnection modules 210 are situated with their respective sidewalls 254, 256 adjacent to and vertically displaced from each other and the rails 256 formed on the sidewalls 246 are slid into the grooves 254 forward on the sidewalls 244 to form the integrated modular array 212. The pair of end interconnection modules 210b are situated so that their sidewalls 244, 246 which constitute the end surfaces of the integrated modular array 212 and from which the locking studs 262 project, face outwardly.

Referring to FIGS. 20A and 20B, detents 274 having upwardly facing shoulders 276 are formed in the outer surfaces of the sidewalls 246 of the bottom housing parts 240a of the housings 216a of at least the intermediate interconnection modules 210a. The detents 274 are formed on a portion of an L-shaped spring portion 278 separated from contiguous segments of the bottom and sidewalls 242 and 246. A correspondingly situated groove 280 having a downwardly facing shoulder 282 is provided in the outer surface of each of the sidewalls 244 of the lower housing parts. Upon assembly of one interconnection module to another, as the dovetail-shaped rails slide within the dovetail-shaped grooves, the detent 274 bears against the adjacent sidewall 244 and urges spring portion 278 inwardly. When the upwardly facing shoulder 276 of detent 274 passes the downwardly facing shoulder 282 of groove 280, the detent snaps into the groove under the return force of the spring portion 278 so that the upwardly and downwardly facing shoulders 276, 282 are in opposed interfering relationship. In this configuration, it is not possible to slide a housing of one interconnection module with respect to the housing of another interconnection module to which it is attached due to the interfering engagement of the opposed shoulders. If it is desired to detach the two interconnection modules from each other, it is only necessary to push a button pad 284 formed on the bottom wall segment of the L-shaped spring portion 278 to pivot the sidewall segment of the spring portion 278 inwardly to disengage the shoulders 276, 282 from each other to permit sliding of the rails 256 within the grooves 254 and detachment of the two previously attached interconnection modules from each other.

Referring to FIGS. 24 and 25, as in the case of the embodiment shown in FIGS. 1-16, an adapter panel 286 may be provided to facilitate mounting of the integrated modular array 212 in a patch panel. The adapter panel 286 is generally similar in construction to the adapter panel 80 shown in FIG. 14 but differs in certain respects. For example, five equally-spaced tabs 288 (as opposed to four in adapter panel 80) extend rearwardly from the bottom wall 290 of the adapter panel 286 and define four slots 292 between them. The top wall 294 of the adapter panel 286 is extended over its entire length to include a holding portion 296 that terminates at its free end at an indented spring surface 296a. A pair of spring arms 298 extend rearwardly from the sidewalls 300 of the adapter panel and terminate at indented spring surfaces 302a. An opening 304 is formed in each spring surface 302a of each spring arm 298.

As in the case of the interconnection modules of the embodiment of FIGS. 1-16, a shallow, longitudinally extending shoulder 298 is formed on the central region of the outer surface of the bottom walls 242 of each of the bottom parts 240 of interconnection modules 210. In the case of intermediate interconnection modules 210a (see FIG. 20B), the shoulder 298 has gaps 300 to allow flexure of the L-shaped spring potion 278. The button pad 284 formed on the spring portion 278 constitutes part of the shoulder 298.

In assembling the integrated modules array 212 into the adapter panel 28b, the array 212 is situated such that the shoulders 282 on the bottom walls of the interconnection modules are aligned with respective slots 292 between tabs 288. The array 212 is moved inwardly so that the bottom walls 242 of the interconnection modules are supported on respective tabs 288. The spring surface 296a of the holding portion 296 extending from the top wall of the adapter panel bears against the outer surfaces of the top walls 258 of the cover parts 252 of all of the interconnection modules 210. The spring surfaces 298a of spring arms 298 are urged against the outer surfaces of the outwardly facing sidewalls 244, 246 of the end interconnection modules 210b. The locking studs 262 snap into the openings 302 in the spring arms 298 when the integrated modular array has been fully inserted into the adapter panel thereby locking the integrated modular array in position. A quick release component 304 may be snapped onto one or both of the spring arms 298 having a projection 306 through which a bore 308 is formed. A cord (not shown) can be attached to the quick-release component through bore 308 so that when it is desired to unlock the integrated modular array from the adapter panel, the cord is pulled to flex the spring arms outwardly to remove the locking studs 262 from within the openings 302 in the spring arms 298 and permits withdrawal of the integrated modular array from the adaptor panel.

Obviously, numerous modifications and variations of the present invention are possible in the light of the above teachings. For example, and without limitation, the couplers of the integrated connector modules may be designed to receive other types of optical fiber connectors than as discussed above. The cable assembly may include other numbers of integrated connector modules than shown in the above-described embodiment, and each module may include more or less than the two couplers shown in the illustrated embodiments. Elements for connecting the integrated connector modules to each other besides the dovetail-shaped grooves and rails are possible within the scope of the invention. It is therefore understood that within the scope of the claims, the invention may be varied from the embodiments disclosed above.

I claim:

1. A fiber optic cable assembly, comprising:
a plurality of optical fibers included in at least one fiber optic cable;
a plurality of connectors pre-terminating at least some of said optical fibers;
a plurality of interconnection modules, each interconnection module including at least one coupler, each coupler including at least one coupling passage having first and second ends;
said first ends of said coupling passages structured and arranged to receive and hold said connectors pre-terminating said optical fibers;
at least some of said connectors of said pre-terminated optical fibers of said at least one fiber optic cable received and held in respective first ends of said coupling passages of said couplers of said plurality of interconnection modules so as to be pre-connected to said interconnection modules; and wherein
said second ends of said coupling passages of each of said couplers structured and arranged to receive and hold connectors terminating other optical fibers to which the optical fibers of said at least one cable are to be optically coupled.

2. A fiber optic cable assembly as recited in claim 1 wherein each interconnection module includes a plurality of couplers.

3. A fiber optic cable assembly as recited in claim 2 wherein each interconnection module includes two couplers and wherein said two couplers are stacked one over the other.

4. A fiber optic cable assembly as recited in claim 1 wherein each coupler includes a plurality of coupling passages.

5. A fiber optic cable assembly as recited in claim 1 wherein each coupler includes a single coupling passage.

6. A fiber optic cable assembly as recited in claim 1 wherein each interconnection module includes a housing for holding and at least partially enclosing said at least one coupler.

7. A fiber optic cable assembly as recited in claim 6 wherein said housing includes elements for fixing said at least one coupler in said housing.

8. A fiber optic cable assembly as recited in claim 6 wherein said connectors and portions of said fiber optic cables proximate to said connectors are situated in said housing.

9. A fiber optic cable assembly as recited in claim 6 wherein each housing comprises a bottom, a pair of sidewalls and a top wall.

10. A fiber optic cable assembly as recited in claim 9 wherein each housing includes connecting elements provided on at least one of said housing sidewalls structured and arranged to engage connecting elements provided on a sidewall of another housing to connect said interconnection modules to each other to form an integrated modular array.

11. A fiber optic cable assembly as recited in claim 10 wherein said connecting elements comprise interlocking grooves and rails provided on said sidewalls of said housings.

12. A fiber optic cable assembly as recited in claim 1 wherein each interconnection module includes connecting elements structured and arranged to engage connecting elements of another interconnection module to connect said interconnection modules to each other to form an integrated modular array.

13. A fiber optic cable assembly as recited in claim 12 wherein each of said interconnection modules includes a housing for holding and at least partially enclosing said at least one coupler, said housing comprising at least a pair of sidewalls, and wherein said connecting elements comprise interlocking grooves and rails provided on said sidewalls of said housings of said interconnection modules.

14. A fiber optic cable assembly as recited in claim 13 wherein said connecting elements further comprise detents formed on said housing sidewalls structured and arranged to engage each other after said interconnection modules are connected to each other to prevent detachment of said interconnection modules from each other.

15. A fiber optic cable assembly as recited in claim 12 further including an adapter panel for mounting in a patch or other distribution panel, said adapter panel having a frame defining an opening for receiving and holding said integrated modular array.

16. A fiber optic cable assembly as recited in claim 15 wherein each of said interconnection modules includes an alignment shoulder and wherein said adapter comprises alignment slots, said alignment shoulders structured and arranged to be received in said alignment slots when said integrated modular array is received and held in said adapter panel opening.

17. A fiber optic cable assembly as recited in claim 15 wherein said adapter panel comprises spring arms for bearing against and holding said integrated modular array in said adapter panel opening.

18. A fiber optic cable assembly as recited in claim 15 wherein said integrated modular array and said adapter panel comprise cooperating elements for locking said integrated modular array in said adapter panel.

19. A fiber optic cable assembly as recited in claim 1 wherein said connectors comprise conventional fiber optic connectors.

20. A fiber optic cable assembly as recited in claim 19 wherein said connectors comprise LC optical connectors.

21. A fiber optic cable assembly as recited in claim 19 wherein said connectors comprise MPO type connectors.

22. A method of making a fiber optic cable assembly, comprising the steps of:
providing a pre-terminated fiber optic cable wherein at least some of the optical fibers thereof are terminated by respective connectors;
providing a plurality of interconnection modules, each interconnection modules including at least one coupler including at least one coupling passage having first and second ends; and
inserting at least some of said connectors into first ends of said couplers of said plurality of interconnection modules prior to installation of said fiber optic cable assembly.

23. A method as recited in claim 22 including the step of connecting said interconnection modules to each other to form an integrated modular array.

24. A method of installing a fiber optic cable assembly, comprising the steps of:
providing at least one fiber optic cable assembly including a plurality of optical fibers, respective connectors terminating at least some of said optical fibers, and a plurality of interconnection modules, each interconnection module including at least one coupler having at least one coupling passage, said connectors inserted and held in first ends of said coupling passages; and
pulling said fiber optic cable assembly through a duct, conduit, plenum or the like with said plurality of interconnection modules separated from each other.

25. A method as recited in claim 24 wherein after the pulling step is completed, connecting said plurality of said interconnection modules to each other to form an integrated modular array.

26. A method as recited in claim 25 wherein after said connecting step is completed, inserting said integrated modular array into an adapter panel for mounting in a patch panel or other distribution panel.
